(19) United States
(12) Patent Application Publication
(10) Pub. No.: US 2004/0113956 A1
(43) Pub. Date: Jun. 17, 2004

(54) Apparatus and method for providing feedback regarding finger placement relative to an input device

(75) Inventors: Thomas Alexander Bellwood, Austin, TX (US); Leugim A. Bustelo, Austin, TX (US); Matthew Francis Rutkowski, Pflugerville, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/317,997

(22) Filed: Dec. 12, 2002

(51) Int. Cl. G09G 5/00

(52) U.S. Cl. 345/863

(57) ABSTRACT

An apparatus and method for providing visual feedback regarding the positioning of a user's fingers relative to an input device are provided. With the apparatus and method, sensors are provided in the input device to sense the proximity of a user's fingers to various portions of the input device. In a preferred embodiment, the sensors are positioned in accordance with the portions of the input device that are manipulated by the user, e.g., keys, buttons, trackball, joystick, and/or the like. When the user places his/her fingers in proximity to the input device, various ones of the sensors will detect the presence of the user's fingers and provide an output signal that is transmitted to the computing device. The output signals are received by the computing device via an input/output interface. The signals are interpreted by a position determination module which provides information to a display generation module. The display generation module generates a visual representation of the input device with indications of where the user's fingers are in relation to the input device, as determined from the interpreted sensor signals. The display may take many forms including a ghost image superimposed over other displayed images, a window in which the input device and finger placement display are depicted.

### BACKGROUND OF THE INVENTION

1. Technical Field

The present invention is directed to an apparatus and method for providing feedback regarding finger placement relative to an input device. More specifically, the present invention is directed to a mechanism for providing a visual representation of the position of a user's fingers in relation to an input device on a display device associated with a computing device to which the input device is coupled.

2. Description of Related Art

Input devices, e.g., keyboards, gamepads, game controllers, touchpads, trackball devices, computer mouse devices, and the like, are often used as a mechanism through which a user may provide input to a computing device to perform various functions. With conventional computing devices, a user is required to direct their attention away from the display unit of the computing device to the input device in order to verify the positioning of their fingers relative to the input device. This can cause distraction and interrupted work flow.

The amount of distraction dramatically increases in low light environments. For example, it becomes difficult to verify finger position on a keyboard of a laptop computer when on airplanes, trains, and the like, where low light is preferred during night time in order to not disturb other passengers. Similar problems with distraction occur when the input device is partially or totally obscured from view.

Thus, it would be beneficial to have an apparatus and method for providing feedback on a display device regarding the positioning of a user's fingers relative to an input device.

### SUMMARY OF THE INVENTION

The present invention provides an apparatus and method for providing visual feedback regarding the positioning of a user's fingers relative to one or more keys of an input device. Herein, the term “keys”, in a preferred embodiment, are specified portions of a touch sensitive device. These specified portions may be movably distinct portions of the touch sensitive device. In some embodiments, such as with a touch sensitive overlay, the specified portions may or may not have any movably distinct elements. Examples of keys that may be used with the present invention include buttons, switches, keyboard keys, trackballs, joysticks, gamepad controls, portions of a touchpad, portions of a touch sensitive overlay, and the like. In a preferred embodiment, the “keys” are physically actuatable portions of an input device.

With the apparatus and method of the present invention, sensors are provided in the input device to sense the proximity of a user's fingers to various keys of the input device. By “proximity”, what is meant is that the present invention may include sensors that detect actual contact of a user's fingers to keys of the input device or merely the presence of a user's fingers close to keys of the input device, but without actual contact, prior to actuation of the key of the input device. The particular “proximity” that is detected is dependent upon the type of sensor mechanism chosen. In a preferred embodiment, the sensors are positioned in accordance with the keys of the input device that are manipulated by the user, e.g., keys, buttons, trackball, joystick, and/or the like.

When the user places his/her fingers in proximity to the input device, various ones of the sensors will detect the presence of the user's fingers and provide an output signal that is transmitted to the computing device. The output signals are received by the computing device via an input/output interface. The signals are interpreted by a position determination module which provides information to a display generation module. The display generation module generates a visual representation of the input device with indications of where the user's fingers are in relation to the input device, as determined from the interpreted sensor signals. The display may take many forms including a ghost image superimposed over other displayed images, a window in which the input device and finger placement display are depicted.

Thus, with the present invention, visual feedback is provided on a computer display device regarding the position of a user's fingers relative to an input device. In this way, the user need not turn his/her attention away from the display device in order to verify his/her finger position relative to the input device. As a result, less distraction is experienced by the user.

These and other features will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a computing device in which the present invention may be implemented;

FIG. 2 is an exemplary block diagram of the primary operational components of a computing device in which the present invention may be implemented;

FIG. 3 is an exemplary block diagram of the primary operational components of a feedback mechanism according to the present invention;

FIG. 4 is an example display generated using the present invention; and

FIG. 5 is a flowchart outlining an exemplary operation of the present invention.

### DETAILED DESCRIPTION OF THE PREFERRED EMBODIMENT

The present invention is directed to mechanisms for detecting the position of a user's fingers in relation to an input device and then generating visual feedback on a computer display device indicating the positioning of the user's fingers. Since the present invention is used in conjunction with a computing device and associated input devices, a brief description of a standard computing device in which the present invention may be implemented will first be provided.

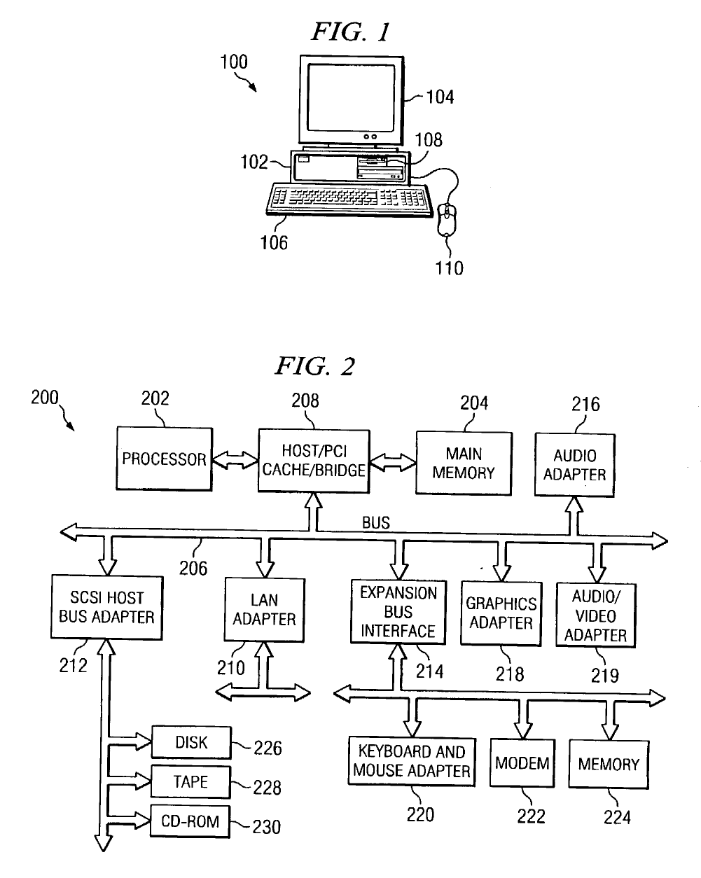

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection.

In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

As mentioned previously, the present invention provides a mechanism for providing visual feedback regarding the positioning of a user's fingers relative to an input device. With the present invention, the input device is provided with one or more user manipulatable portions, e.g., buttons, keyboard keys, trigger-type controls, directional pad controls, joystick-type controls, touchpad portion, or the like. Hereafter, these user manipulatable portions of the input device, whether they be movably distinct or not, will collectively be referred to as “keys.” One or more sensors are positioned in association with the one or more user manipulatable keys and a coupling mechanism is provided for coupling the input device to a computing device. The coupling mechanism may be, for example, a serial cable connection, a parallel cable connection, a wireless connection, such as infrared or radio wave connection, or the like. The one or more sensors are configured to detect the presence of a portion of a user within a proximity of the one or more sensors prior to the user operating the associated key of the input device. The one or more sensors send signals indicative of the presence of a key of a user to the computing device via the coupling mechanism.

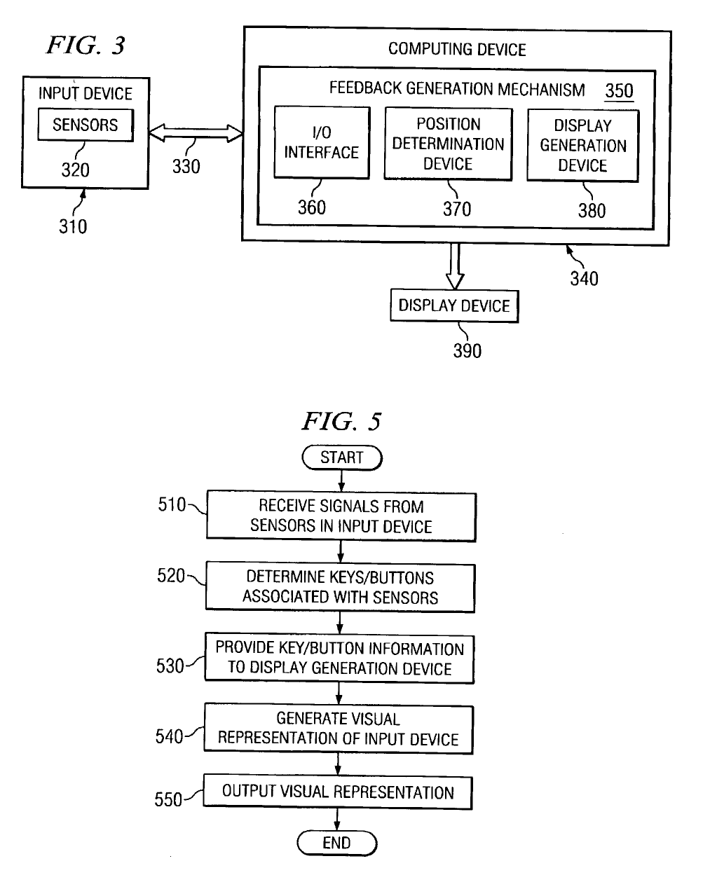

FIG. 3 is an exemplary block diagram illustrating the primary operational elements of the present invention. As shown in FIG. 3, sensors 320 are provided in an input device 310 for detecting the presence of a user's fingers, or other portion of a user, in proximity to the sensors 320. The sensors 320 detect the presence of the portion of the user prior to the user operating the input device. In other words, the user need not purposefully activate or use the input device in order for the sensors 320 to detect the presence of the portion of the user. Hereafter, the portion of the user will be assumed to be the user's fingers, but it should be understood that the present invention is not limited to detection of finger placement, and may be applied to any portion of a user that is placed within proximity to the sensors 320.

The sensors 320 provide signals to the computing device 340 via the signal lines 330. These signals may take the form of interrupt signals, keyboard event signals, and the like. The signals are received in the computing device 340 which processes these signals to determine where the user's fingers are located in relation to the input device 310.

The processing of the signals received from the sensors 320 may be performed, for example, using firmware and/or device driver software applications. A firmware approach allows the present invention to be used with any operating system. A device driver approach requires that device drivers be generated for each input device and each operating system. However, the device driver approach may be easier for vendors to implement.

In a firmware approach, the firmware provides access to the computing device 340 BIOS/ABIOS where, in some embodiments, some of the input/output code necessary to detect the signals from the sensors may reside. In addition, this firmware may communicate with a low-level device driver in an operating system, such as Microsoft Windows XP™ or the like, at an interrupt level such that the device driver interprets the sensors signals received.

In alternative embodiments, a new interrupt may be provided for communicating the detection of a user's fingers in proximity to a key of an input device via the sensors. In yet other embodiments, existing input device interrupts that are already supported are modified to provide additional information to the low level device drivers of the present invention. In such alternative embodiments, the firmware of the computing device 340 need not be modified from that of generally known computing devices since the functionality for implementing the features of the present invention lies in the new or modified interrupt and the device driver software.

Based on the determination as to where the user's fingers are in relation to the input device 310, a graphical representation of the input device along with indications of the position of the user's fingers is generated and output on a display device 350 associated with the computing device 340.

The sensors 320 may be any type of sensor that may be used to detect the presence of a user's finger in proximity to the sensors 320. By “proximity”, what is meant is that the present invention may include sensors that detect actual contact of a user's fingers to keys of the input device or merely the presence of a user's fingers close to keys of the input device, but without actual contact, prior to actuation of the key of the input device. The particular “proximity” that is detected is dependent upon the type of sensor mechanism chosen.

For example, the sensors 320 may include electro-static based sensors, pressure sensors, fiber optic based sensors, heat based sensors, and the like. With electro-static based sensors, for example, an electromagnetic coil may be positioned in relation to a user's manipulatable key of the input device. When a user's finger is placed in proximity to the coil, the flux in the coil will change. This change in flux may be detected and used to indicate the position of the user's finger over the corresponding key, button, etc.

With pressure sensors, for example, multiple contact points in a spring loaded plunger type key or button may be provided. That is, various resistances may be provided by springs in the key or button. A first resistance may allow a user to depress the key or button slightly when the user's finger rests on the key or button. This slight depression may be detected and used as a basis for identifying the presence of the user's finger over the key or button. A larger resistance may be provided in order to depress the key or button further so that actual user intended input using the key or button is generated.

With fiber optic based sensors, for example, an additional fiber optic sensor is provided in each key or button. The fiber optic sensor may be, for example, a fiber optic interferometer such as a Fabry Perot fiber optic interferometer. Fabry Perot fiber optic interferometers are generally known in the art and more information about these type of fiber optic interferometers may be found at http://sensor.nad.ru/sensors/English/interf.htm, which is hereby incorporated by reference.

With heat based sensors, the presence of a user's fingers near keys of an input device may be detected based on the heat radiated by the user's fingers. A change in temperature, of a sufficient amount, at the keys of the input device in which the sensors are incorporated may be indicative of the presence of a user's finger in the proximity of those keys of the input device. In this way, the presence of the user's fingers may be detected without requiring actual contact of the user's fingers with the keys of the input device.

Moreover, the sensors may be a combination of sensors. For example, the sensors may include a first sensor for detecting the proximity of the user's finger to the key of the input device and a second sensor may be provided for detecting initial actuation of the key of the input device. Mores specifically, in one exemplary embodiment, a heat sensitive sensor may be used to determine a user's finger being in proximity to the key while actual actuation of the key may be detected using one of the other types of sensors or a conventional sensor for detecting the depressing of the key to make electrical contact.

In a preferred embodiment, the sensors 320 are placed or positioned in the input device 310 in accordance with the user manipulatable keys of the input device 310. For example, in a keyboard input device, the sensors 320 are placed relative to the keys of the keyboard so that when a user's finger is positioned over a key, the corresponding sensor will detect the presence of the user's finger over that key. Similarly, in a gamepad or game controller device, typically having a plurality of buttons which may be operable by a user, the sensors 320 are positioned according to the placement of the buttons so that the sensors 320 may detect the presence of a user's fingers in proximity to the buttons.

The sensors 320 send signals to the computing device 340 which uses the sensors signals to generate a display of the input device 310 with designations as to finger placement. The computing device 340 may be any type of computing device that may receive input signals from an input device 310. For example, the computing device 340 may be a personal computer, a laptop computer, a personal digital assistant, a portable computer, or the like.

The computing device 340 includes a feedback generation mechanism 350 that generates the visual feedback regarding the user's finger placement in relation to the input device 310, as determined from the sensors 320. The feedback generation mechanism 350 includes an input/output interface 360, a position determination device 370 and a display generation device 380. The feedback generation mechanism 350 and its corresponding components 360-380 may be implemented as software, hardware, or any combination of software and hardware without departing from the spirit and scope of the present invention. In preferred embodiments, the feedback generation mechanism 350 is implemented in firmware and/or device drivers for each type of input device 310 for which visual feedback is to be generated.

The sensor signals from sensors 320, received by the computing device 340 via the signal lines 330, are provided to the feedback generation mechanism 350 via the input/output interface 360. The position determination device 370 receives the sensor signals via the input/output interface 360 and determines the buttons, keys, etc., over which the user's fingers are placed as detected from the sensors 320. This may be done using a key or button map, to identify the specific keys, buttons, etc. of the input device 310 over which the user's fingers are placed.

This finger placement information is then provided to the display generation device 370 which generates the appropriate commands to generate a visual representation of the input device with visual indications of the position of the user's fingers in relation to the input device 310. As mentioned previously, the visual representation may take many forms including a superimposed “ghost” image of the input device, a windowed display of the input device, a miniature key map presented in a designated area of the screen on the display device, or the like. In a preferred embodiment, the visual representation takes the form of a “ghost” image superimposed over other graphical elements displayed on the display device. Similar “ghost” images are used, for example, with IBM Thinkpads™ which provides cyan-blue images that are overlayed/superimposed over video output. Another similar “ghost” image is used in television controls where a visual display of volume, brightness, etc. are temporarily displayed superimposed over the video output of the television when input to these controls is received.

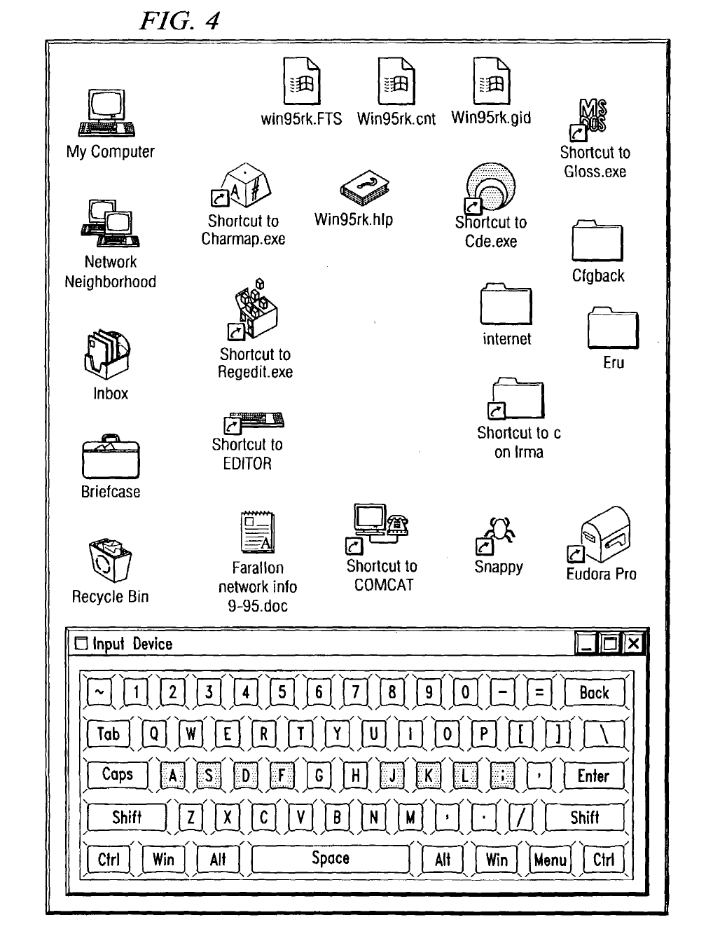

FIG. 4 is an exemplary diagram illustrating one possible implementation of the present invention. As shown in FIG. 4, the user's fingers are currently over the “A”, “S”, “D”, “F”, “J”, “K”, “L” and “;” keys on the input device, which in this case is a keyboard. Sensors built into the keyboard at each of the locations corresponding to these keys sense the proximity of the user's fingers to these keys and provide signals to the computing device indicating that the sensors have detected the presence of a user's finger. The feedback mechanism of the present invention then generates a visual representation 410 of the input device on the display screen 420 of the computing device.

As shown in FIG. 4, the visual representation 410 is a representation positioned in a lower portion of the display screen 420. The visual representation 410 is a graphical depiction of the input device with the keys over which the user's fingers are currently placed being highlighted. Any visually significant manner may be used to accentuate which keys of the input device the user's fingers are currently positioned over without departing from the spirit and scope of the present invention. For example, a different color may be used, highlighting, enlarging of those keys of the input device, flashing or blinking effects, and the like may be used to distinguish those keys having the user's fingers placed over them from those keys that do not.

It should be noted that while the specific example shown in FIG. 4 is a graphical representation of the input device positioned in a predefined region of the display screen 420, the present invention is not limited to any one type of visual representation of the input device. Rather, any visual representation may be used without departing the spirit and scope of the present invention.

As noted previously, windowed and “ghost” images may be used to provide the visual representation of the input device. Other visual representations may include displaying only indicators of those keys, buttons, etc. over which the user's fingers are positioned without displaying the entire input device, displaying key or button indicators in a toolbar of the display screen 420, or the like. The number of various types of visual representations that may be used with the present invention is too large to discuss each one herein, however these other possible visual representations would be readily apparent to one of ordinary skill in the art in view of the present description of the preferred embodiments.

In addition to the above, a utility may be provided on the computing device for interfacing with the position determination device to thereby input parameters governing the operation of the position determination device. Such parameters may be stored, for example, in a configuration file associated with and read by the position determination device which uses these parameters to adjust its operation. The parameters may include, for example, threshold information for adjusting the sensitivity of the sensors. That is, the user may adjust a threshold value that indicates a required signal level from the sensors before an indication that the user's finger is present will be made.

Furthermore, the user may input commands to turn on/off the position determination of the present invention or the feedback display. Other operational parameters, such as position of the visual representation on the display, the type of visual representation to provide, and the like, may be input by the user using a utility such as that described above.

Moreover, the user input may indicate when the feedback display is to be displayed. For example, the feedback display may be displayed at all times or only in response to certain events. Such events may include the removal of all contact with the input device and subsequent detection of contact with the input device. This signifies a user removing his hands from the input device and then later repositioning his hands on the input device. It is at such times that the benefits of the present invention may be especially useful in providing the user a visual cue as to where his fingers are in relation to where the user intended his fingers to be. The device driver software of the present invention provides code for determining when no input is received from the sensors of the input device and using such an event as an instigator of the determination to display the visual representation once an input is received from the sensors.

In addition to the above, the feedback generation mechanism of the present invention may interface with a currently active application to obtain a key or button map for the particular application. This key or button map may then be used to correlate the keys or buttons of the standard input device visual representation with the functions assigned to those keys or buttons in the application.

That is, often applications have specific functions assigned to particular keys and/or buttons of an input device. Rather then the visual representation of the present invention only showing the same standard visual representation of the input device regardless of the application, the visual representation may be customized to the currently active application such that key/button labels are specific to the currently active application.

For example, in a computer game application, the “W” key on a keyboard may be mapped to a “move forward” operation and the “space bar” key may be mapped to a “jump” operation. Rather, than displaying the normal representation of the input device, these mapping tags may be provided in the visual representation of the input device. Thus, rather than the visual representation showing the “W” key, a “forward” key may be illustrated in the visual representation. Similarly, rather than a “space bar” being illustrated, a “jump” key may be illustrated in the visual representation of the input device.

FIG. 5 is a flowchart outlining an exemplary operation of the present invention. The flowchart in FIG. 5 assumes that visual feedback according to the present invention has been enabled by the user. As shown in FIG. 5, the operation starts with receiving signals from sensors in an input device (step 510). As previously mentioned, the signals may be received and handled by firmware and/or a device driver associated with the input device. The firmware and/or device driver provide a mechanism for interpreting the signals received.

The signals are processed to determine the keys or buttons associated with the sensors from which the signals were received (step 520). As previously discussed above, this determination may be made based on a key or button map associated with the input device. In addition, this determination may further be based on information obtained from a key or button map associated with a particular active application.

The key or button information is then provided to a display generation device (step 530). The visual representation of the input device with user's finger placement shown is then generated (step 540) and output (step 550). The visual representation may take many forms as previously discussed. The display generation device may consult a configuration or user preferences file to determine which type of visual representation to generate and/or where on the display screen the visual representation is to be displayed.

Thus, with the present invention, visual feedback is provided on a computer display device regarding the position of a user's fingers relative to an input device. In this way, the user need not turn his/her attention away from the display device in order to verify his/her finger position relative to the input device. As a result, less distraction is experienced by the user. Moreover, users that may have special needs, such as those who have a physical impairment that causes finger/hand placement to be difficult, may be aided by the visual feedback mechanism of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing device, for providing visual feedback of the position of a portion of a user relative to an input device, comprising:
receiving a signal from a sensor in the input device, the signal being generated based on a presence of a portion of a user within a proximity of the sensor;
determining a key of the input device corresponding to the sensor from which the signal is received;
generating a visual representation of the input device based on the determination of the key of the input device; and
outputting the visual representation of the input device to a display device, wherein the sensor detects the presence of the portion of the user prior to the user operating the key of the input device.

2. The method of claim 1, wherein the sensor include is one of a fiber optic sensor, an electromechanical sensor, a pressure sensor, and a heat sensor.

3. The method of claim 1, wherein the visual representation includes at least one of a windowed graphical display of a key of the input device, a graphical representation of a key of the input device at a predetermined position on a graphical display output on the display device, and a superimposed image of a key of the input device on the display device.

4. The method of claim 1, wherein determining the key of the input device corresponding to the sensor includes using a key/button map to identify a key/button associated with the sensor.

5. The method of claim 4, wherein the key/button map is specific for a currently active application.

6. The method of claim 1, wherein the input device is one of a keyboard, computer mouse, trackball device, gamepad, touchpad, and a game controller.

7. The method of claim 1, wherein the visual representation includes indications of the position of a user's fingers in relation to the input device.

8. The method of claim 1, wherein determining a key of the input device corresponding to the sensor from which the signal is received, generating a visual representation of the input device, and outputting the visual representation of the input device are performed by a device driver.

9. The method of claim 1, wherein determining a key of the input device corresponding to the sensor from which the signal is received includes:
determining if a signal level of the signal is above a required threshold signal level.

10. The method of claim 1, further comprising:
determining if there is a period of no signal being received from any sensor in the input device, wherein the visual representation of the input device is output only when there is a period of no signal being received prior to receiving the signal from the sensor.

11. A computer program product for providing visual feedback of the position of a portion of a user relative to an input device, comprising:
first instructions for receiving a signal from a sensor in the input device, the signal being generated based on a presence of a portion of a user within a proximity of the sensor;
second instructions for determining a key of the input device corresponding to the sensor from which the signal is received;
third instructions for generating a visual representation of the input device based on the determination of the key of the input device; and
fourth instructions for outputting the visual representation of the input device to a display device, wherein the sensor detects the presence of the portion of the user prior to the user operating the key of the input device.

12. The computer program product of claim 11, wherein the visual representation includes at least one of a windowed graphical display of a key of the input device, a graphical representation of a key of the input device at a predetermined position on a graphical display output on the display device, and a superimposed image of a key of the input device on the display device.

13. The computer program product of claim 11, wherein the second instructions for determining the key of the input device corresponding to the sensor include instructions for using a key/button map to identify a key/button associated with the sensor.

14. The computer program product of claim 13, wherein the key/button map is specific for a currently active application.

15. The computer program product of claim 11, wherein the visual representation includes indications of the position of a user's fingers in relation to the input device.

16. The computer program product of claim 11, further comprising:
fifth instructions for receiving at least one operational parameter; and
sixth instructions for controlling at least one of determining the key of the input device corresponding to the sensor and generating the visual representation of the input device based on the at least one operational parameter.

17. The computer program product of claim 11, wherein the second instructions for determining a key of the input device corresponding to the sensor from which the signal is received include:
instructions for determining if a signal level of the signal is above a required threshold signal level.

18. The computer program product of claim 16, wherein the at least one operational parameter includes an operational parameter identifying at least one of a type of visual representation and a position of the visual representation on a display device.

19. The computer program product of claim 11, further comprising:
fifth instructions for determining if there is a period of no signal being received from any sensor in the input device, wherein the visual representation of the input device is output only when there is a period of no signal being received prior to receiving the signal from the sensor.

20. An apparatus for providing visual feedback of the position of a portion of a user relative to an input device, comprising:
means for receiving a signal from a sensor in the input device, the signal being generated based on a presence of a portion of a user within a proximity of the sensor;
means for determining a key of the input device corresponding to the sensor from which the signal is received;
means for generating a visual representation of the input device based on the determination of the key of the input device; and
means for outputting the visual representation of the input device to a display device, wherein the sensor detects the presence of the portion of the user prior to the user operating the key of the input device.

21. A system, comprising:
A computing device; and
an input device, coupled to the computing device, having a sensor for detecting the presence of a portion of a user within a proximity of the sensor, wherein the sensor provides a signal to the computing device indicative of the presence of a portion of the user within proximity of the sensor, and wherein the computing device determines a key of the input device corresponding to the sensor and outputs a visual representation of the input device based on the determination of the key of the input device.

22. The system of claim 21, wherein the sensor include is one of a fiber optic sensor, an electromechanical sensor, a pressure sensor, and a heat sensor.

23. The system of claim 21, wherein the input device is one of a keyboard, computer mouse, trackball device, gamepad, touchpad, and a game controller.

24. The system of claim 21, wherein a device driver for the input device resident in the computing device is used to determine a key of the input device corresponding to the sensor from which the signal is received and output the visual representation of the input device.

25. An input device for use with a computing device, comprising:
one or more user manipulatable keys;
one or more sensors positioned in association with the one or more user manipulatable keys; and
a coupling mechanism for coupling the input device to the computing device, wherein the one or more sensors are configured to detect the presence of a portion of a user within a proximity of the one or more sensors prior to the user operating the associated key of the input device, and wherein the one or more sensors send a signal indicative of the presence of a portion of a user to the computing device via the coupling mechanism.
